(19) United States
(12) Patent Application Publication
(10) Pub. No.: US 2019/0259297 A1
(43) Pub. Date: Aug. 22, 2019

(54) System and Method for Assisting Challenged Readers

(71) Applicants: Dana C. Torrey, II, Pacific Palisades, CA (US); Rosemary Ford, Santa Monica, CA (US)

(72) Inventors: Dana C. Torrey, II, Pacific Palisades, CA (US); Rosemary Ford, Santa Monica, CA (US)

(21) Appl. No.: 16/278,544

(22) Filed: Feb. 18, 2019

Related U.S. Application Data
(60) Provisional application No. 62/632,882, filed on Feb. 20, 2018.

(51) Int. Cl. G09B 17/00; G06F 17/27

(52) U.S. Cl. CPC G09B 17/003; G06F 17/2785; G06F 17/274; G06F 17/2705

(57) ABSTRACT

A System and Method for Assisting Challenged Readers is disclosed. The system and method permits a user to upload an electronic file containing text, after which the system breaks the text into strings. Next, the system and method iteratively examines each string to determine whether or not the string is a word. Word strings are colorized by their syllables according to a pre-determined colorization scheme. As syllables are colorized, they are added to an output file according to a pre-determined font scheme, until all text and strings have been colorized and added to the output file. The output file is then provided to the user for reading. In this manner, text previously unreadable to challenged readers is now presented in a colorized form that these readers should be able to read with considerably more ease and speed.

This application is filed within one year of, and claims priority to Provisional Application Ser. No. 62/632,882, filed Feb. 20, 2018.

### BACKGROUND OF THE INVENTION

### 1. Field of the Invention

This invention relates generally to text conversion systems and, more specifically, to a System and Method for Assisting Challenged Readers.

### 2. Description of Related Art

Dyslexia is the most common learning disability and occurs in all areas of the world.¹² It is believed to affect 3-7% of the population,³ however, up to 20% may have some degree of symptoms. Dyslexia is a reading disorder characterized by trouble with reading despite normal intelligence.⁴ Different people are affected to varying degrees.⁵ ¹ National Institute of Neurological Disorders and Stroke. National Institutes of Health. 11 Sep. 2015. Retrieved 27 Jul. 2016.² Darcy Ann Umphred; Rolando T. Lazaro; Margaret Roller; Gordon Burton (2013). Neurological Rehabilitation. Elsevier Health Sciences. p. 383.³ Kooij, J. J. Sandra (2013). Adult ADHD diagnostic assessment and treatment (3rd ed.). London: Springer. p. 83.⁴ Siegel, L S (November 2006). “Perspectives on dyslexia.”. Paediatrics & child health. 11 (9): 581-7.⁵ “What are reading disorders?”. National Institutes of Health. Retrieved 15 Mar. 2015.

Problems may include difficulties in spelling words, reading quickly, writing words, “sounding out” words in the head, pronouncing words when reading aloud and understanding what one reads. Often these difficulties are first noticed at schoo1.⁶ The difficulties are involuntary and people with this disorder have a normal desire to learn.

The cause of dyslexia is believed to involve both genetic and environmental factors. Some cases run in families. It often occurs in people with attention deficit hyperactivity disorder (ADHD) and is associated with similar difficulties with numbers. It may begin in adulthood as the result of a traumatic brain injury, stroke, or dementia. The underlying mechanisms of dyslexia are problems within the brain's language processing. Dyslexia is diagnosed through a series of tests of memory, spelling, vision, and reading skills.

Historically, treatment has involved adjusting teaching methods to meet the person's needs. While not curing the underlying problem, a decrease in the degree of symptoms has at times been seen.⁷ While numerous partial aides have been developed and/or have evolved over the years, none has been found to be universally successful in both temporarily aiding reading skills, while also improving reading skills of dyslexic individuals in a prolonged fashion. ⁶ Peterson, R L; Pennington, B F (26 May 2012). “Developmental dyslexia.” (PDF). Lancet. 379 (9830): 1997-2007.⁷ “What are common treatments for reading disorders?”. National Institutes of Health. Retrieved 15 Mar. 2015.

What is needed is a tool and method for both temporarily assisting dyslexic individuals in their reading, while also providing long-term improvements in their reading ability.

### SUMMARY OF THE INVENTION

In light of the aforementioned problems associated with the prior systems and methods, it is an object of the present invention to provide a System and Method for Assisting Challenged Readers. The system and method should permit a user to upload an electronic file containing text, after which the system should break the text into strings. Next, the system and method should iteratively examine each string to determine whether or not the string is a word. Word strings should be colorized by their syllables according to a pre-determined colorization scheme. As syllables are colorized, they should be added to an output file according to a pre-determined font scheme, until all text and strings have been colorized and added to the output file. In this manner, text previously unreadable to challenged readers should now be presented in a colorized form that these readers should be able to read with considerably more ease and speed.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is functional diagram of a preferred embodiment of the system of the present invention;

FIG. 2 is a high level summary flowchart depicting the steps of a preferred embodiment of the method of the present invention;

FIG. 3 is a detailed flowchart depicting the steps of a preferred embodiment of the suffix/prefix processing method of the method and system of FIGS. 1 and 2; and

FIG. 4 is a detailed flowchart depicting the steps of a preferred embodiment of the syllable processing method of the method and system of FIGS. 1 and 2.

### DETAILED DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art, since the generic principles of the present invention have been defined herein specifically to provide a System and Method for Assisting Challenged Readers.

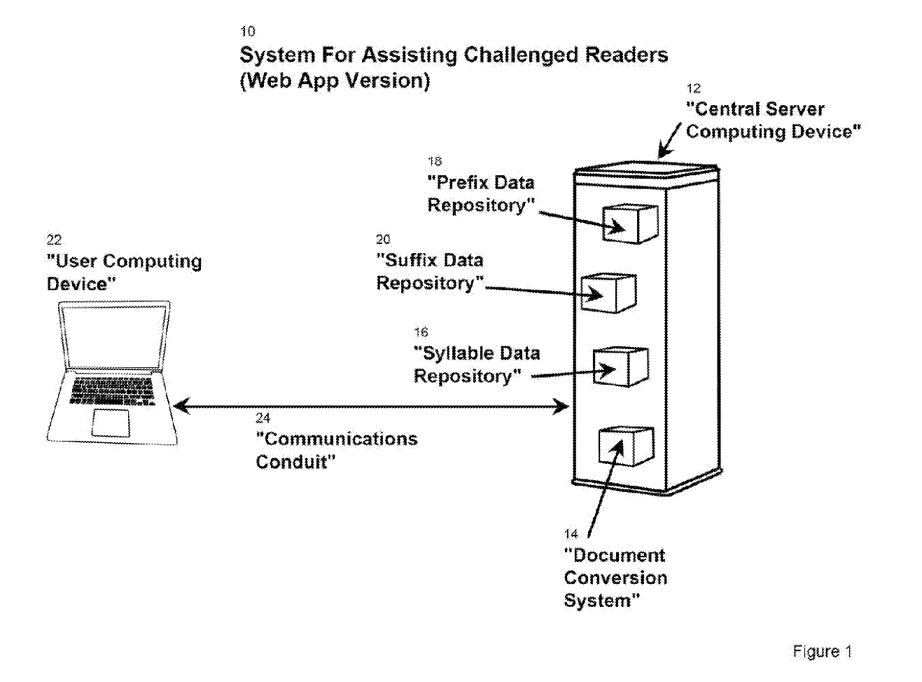

The present invention can best be understood by initial consideration of FIG. 1.⁸ FIG. 1 is functional diagram of a preferred embodiment of the system 10 of the present invention. A variety of different architectures may be employed for the system 10, with the depicted components being only one example. The document conversion system 14 is the software “engine” for converting a user's uploaded text into a format that has been proven to be much easier for dyslexic readers to read. There are a plurality of data repositories associated with the system 14. These repositories or libraries are pre-populated with data related that allows the system 14 to match known prefixes, suffixes and syllables with text in the user's document. The system uses the prefix and suffix tables to find the root of a word which it can then look up in the syllable dictionary. If found, the system then knows where the syllable breaks are and can color the syllables accordingly. ⁸ As used throughout this disclosure, element numbers enclosed in square brackets [ ] indicates that the referenced element is not shown in the instant drawing figure, but rather is displayed elsewhere in another drawing figure.

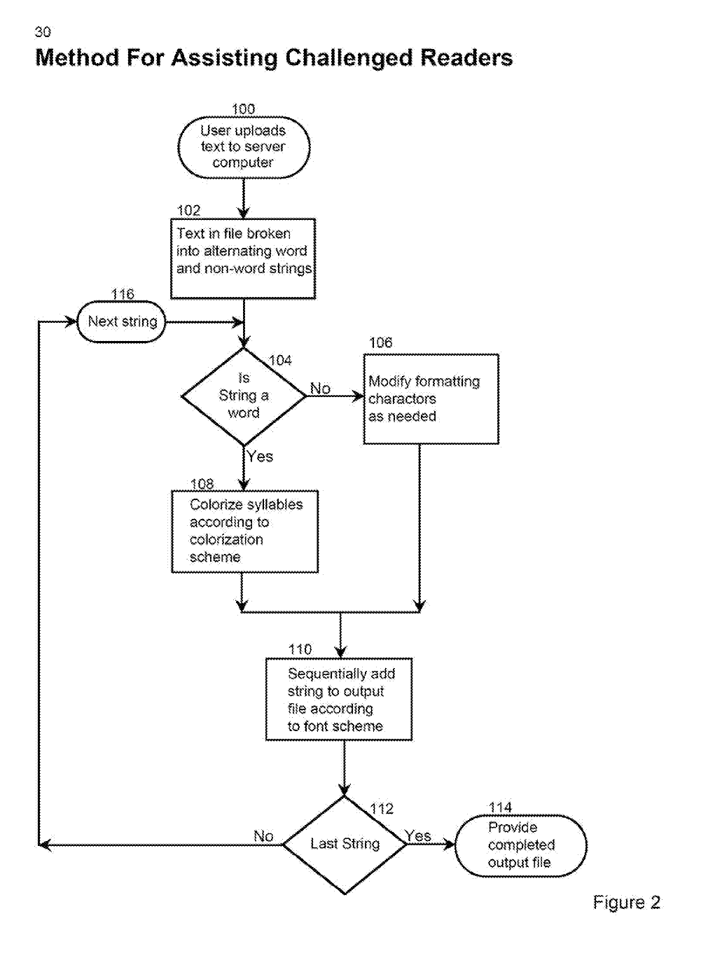

The user can upload their text file from a computing device 22 such as a desktop computer, tablet computer, or other computing device. The uploaded file will reach the central server computing device 12 via communications conduit 24—typically the World Wide Web or other computer network. Once the output file is created by the system 14, it will be made available to the user via download, email or other transfer via the communications conduit 24. Turning now to FIG. 2, we obtain a basic introduction to the invention.

FIG. 2 is a high level summary flowchart depicting the steps of a preferred embodiment of the method of the present invention 30. The user first uploads the text that they'd like to be “translated” or transformed/converted to the server computer 100. Ideally this would be in a file formatted in a conventional word processor format, however, conversion of the input text could be performed by the system [14], if the system is configured to do so.

The text making up the input is broken into alternating strings consisting of words and non-words. The non-words consist of formatting characters, spaces and punctuation. The non-words are processed to remove hard line breaks, section breaks and indents which would prevent the text adjusting to the new margins and font size. The words are reduced to their root and looked up in the syllable dictionary and the syllables colorized according to the colorization scheme 108.

This modified string (i.e. colorized and edited) string is added to the output file (preferably a word processor-formatted file) in the font as per the font scheme 110 established in the system [14]. This will continue until the last string 112 is reached, after which the user will be provided with the completed output file 114 (i.e. with all strings converted into the easy-to-read format).

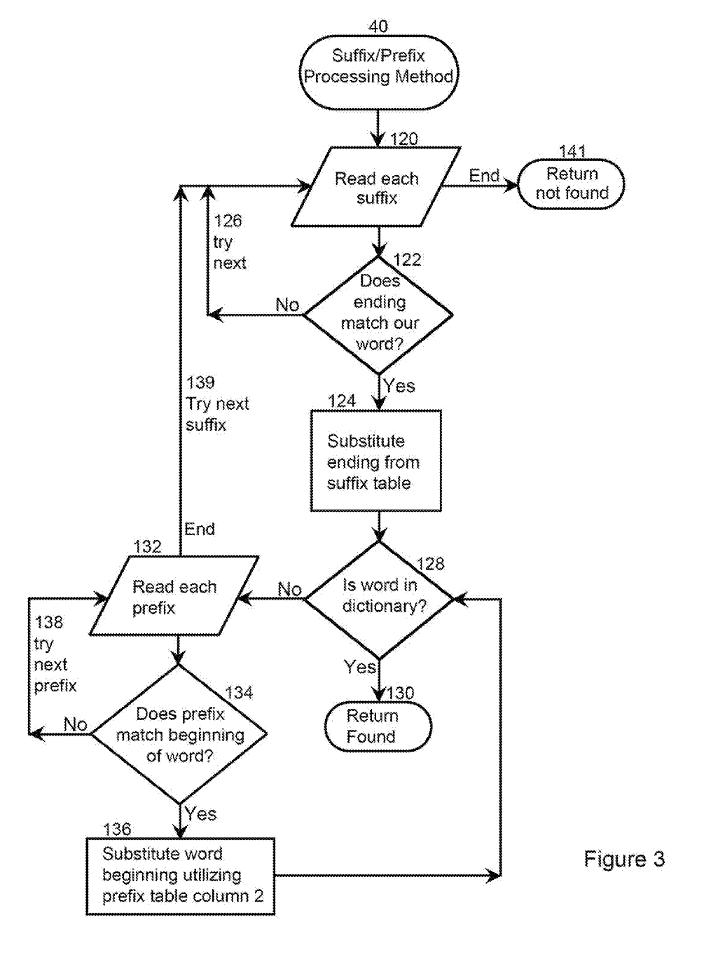

The method that the system executes in processing prefixes and suffixes is detailed in FIG. 3. FIG. 3 is a detailed flowchart depicting the steps of a preferred embodiment of the suffix/prefix processing method 40 of the method and system of FIGS. 1 and 2. Each suffix is read 120 to determine whether the ending of the word matches a word in the suffix repository [20] 122. If it does match, the pre-determined substitute word ending is taken from the suffix repository [20] and replaces the original word ending 124. If the modified word is found in the dictionary (i.e. in the syllable repository [16]) 128, then the word is identified as “found” 130 and the prefix/suffix processing is completed.

If the suffix-modified word is not found in the dictionary [16], then the prefix is read 132 to see if it matches the beginning of a word in the dictionary [16]. If the word is found, then the beginning of the input word is replaced with the pre-determined substitute word beginning that is taken from the prefix repository [18] and the final word is returned as “found” 130 (unless the word is not found).

Each prefix for the input word 138 is read 132 and matched 134 until a word match is achieved and the “found” word is returned 130. If no words are identified by the initial suffix or all of the prefixes, the next suffix 139 is read 120, and if all attempts to word-match fail, “not found” is returned to the system [14] and the input text is not modified for colorization—only the text is modified according the font scheme [110].

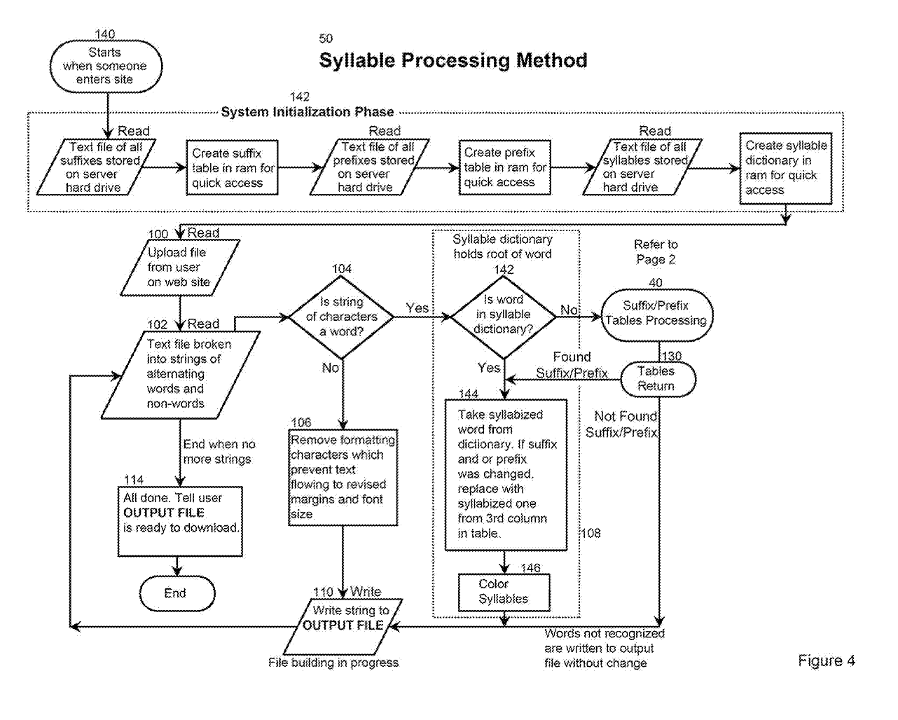

The prefix/suffix processing method 40 is a subset or subroutine that is a part of the detailed syllable processing method 50 of FIG. 4. FIG. 4 is a detailed flowchart depicting the steps of a preferred embodiment of the syllable processing method of the method and system of FIGS. 1 and 2.

When a potential user enters the website portal for the system [14] 140, the system intialization phase commences 141. The intitialization phase 141 involves the suffixes, prefixes and syllables tables/data being retrieved from their respective data repositories ([16, 18, 20]) and placed in Random Access Memory so that access to these tables by the system [14] is as quick as possible—to reduce user wait times.

The user then uploads their file to the site 100 and the text in the file is broken up 102 until all strings have been separated and the output file is prepared for population with the colorized/converted text 114.

For non-words, 106, the non-string data is adjusted and the adjusted non-word is written to the output file (punctuation marks being colorized as described in Table Section C). Words are then colorized according to the colorization scheme 108. If not in the syllable dictionary [16], the suffix/prefix method will be executed on the string 40. If the string is a word found in the dictionary [16] (or after suffix/prefix processing), the syllabalized word is taken from the dictionary [16] to replace the original word 144. The syllables are then colorized according to the scheme of Table I 146, and the colorized, syllablized (converted) word is written to the output file 110 sequentially (so that the words' order in the output file matches the order of the input file).

An example of a word being processed by the system [14] is provided below:
Input word=“happily”
Step 1: remove suffix “ily” (from suffix repository [20]).
Step 2: add suffix “y” (from suffix repository [20]) and search for “happy” in syllable dictionary
Step 3: find “hap_py” in syllable dictionary (in syllable repository [16])
Step 4: remove “y” and replace with “i_ly” syllabilized suffix (found in suffix repository [20])
Step 5: colorize “hap_pi_ly” according to scheme (Table I)
Step 6: Result is

[symbol]

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

TABLE I
Font and Type Schemes
Note: Not all rules are mandatory
A. Font and Spacing rules

| | |
|---|---|
| A1. | 16 point |
| A2. | Bold |
| A3. | typically serif type face |
| A4. | 1.5 line spacing |
| A5. | character spacing 1.7 to 2.0 point |
| A6. | Approximately 6 words per line |
| A7. | titles: 24 point font |

B. Syllable rules

| | |
|---|---|
| B1. | Initial syllable in a word having 3 syllables or |
| | more: Blue text |
| B2. | Final syllable in a word: Orange text |
| B3. | Single-syllable words: Black text |
| B4. | 2-syllable words: |
| | Black text for first syllable |
| | Orange text for second syllable |
| B5. | 3-syllable words: |
| | Blue text for first syllable |
| | Black text for second syllable |
| | Orange text for third syllable |
| B6. | 4-syllable words: |
| | Blue text for first syllable |
| | Black text for second syllable |
| | Red text for third syllable |
| | Orange text for fourth syllable |
| B7. | 5-syllable words: |
| | Blue text for first syllable |
| | Black text for second syllable |
| | Green text for third syllable |
| | Black text for fourth syllable |
| | Orange text for fifth syllable |
| B8. | 6-syllable words |
| | Blue text for first syllable |
| | Black text for second syllable |
| | Green text for third syllable |
| | Black text for fourth syllable |
| | Green text for fifth syllable |
| | Orange text for sixth syllable |

C. Punctuation and Miscellaneous rules

| | |
|---|---|
| C1. | Subtitles: highlighted in yellow |
| C2. | Silent letters: Burgundy Red text |
| C3. | Periods: yellow period, red highlight, followed by extra space |
| C4. | Exclamation point: yellow exclamation point, turquoise |
| | highlight, followed by extra space |
| C5. | Question mark: yellow question mark, bright green highlight, |
| | followed by extra space |
| C6. | Unknown word: text left black (and not underlined) |
| C7. | Foreign language words: Colorize those words that are in the |
| | dictionary, those that are not will be left black (i.e. uncolorized). |

What is claimed is:

1. A system for assisting challenged readers, comprising:
an input device, said input device in communication with a central computing device,
said central computing device comprising:
a prefix data repository;
a suffix data repository;
a syllable data repository; and
a document conversion system, said document conversion system configured to:
reformat text entered by a user at said input device and communicated to said central computing device according to pre-determined prefix, suffix and syllable data rules and responsive to matching said entered text to word, prefix, suffix and syllable data in a word data repository and said prefix, suffix and syllable data repositories, whereby
said text is reformatted such that each syllable component of each said word is displayed in a distinct color relative to the other said components of each word of said text; and
an output subsystem configured to create an output document comprising said reformatted text and transmit said output document to said input device.

2. The system of claim 1, wherein said document conversion system is configured to identify root words in said text entered by said user parsing said text into individual text strings and comparing said text strings to data residing in said word data repository.

3. A method for assisting challenged readers, comprising the steps of:
a user transmitting an input file from an input device to a central computing device, said input file comprising strings of text;
said central computing device analyzing each individual said string of text and determining whether said string of text is a word or a non-word by comparing said string of text to a word data repository in said central computing device;
colorizing words identified in said analyzing step according to a pre-determined colorization ruleset;
adding said colorized words and non-word strings of text to an output file;
iteratively completing said analyzing, colorizing and adding steps to all strings of text in said input file to complete a final output file; and
transmitting said final output file to said input device.

4. The method for assisting challenged readers of claim 3, wherein said colorizing step comprises comparing each said identified word to a syllable text string dictionary located in a syllable data repository of said central computing device and responsively identifying the syllables making up each said identified word.

5. The method for assisting challenged readers of claim 4, wherein said colorizing step further comprises coloring said identified syllables in each said identified word according to a pre-determined syllable colorization rulesubset, said syllable colorization rule subset forming a portion of said pre-determined colorization ruleset.

6. The method for assisting challenged readers of claim 3, wherein said colorizing step further comprises comparing each said identified word to a syllable text string dictionary located in a syllable data repository of said central computing device and responsively comparing each said identified word to a prefix text string dictionary and a suffix text string dictionary located in prefix data repository and suffix data repository, respectively, of said central computing device and responsively identifying prefixes and suffexes in each said identified word.

7. The method for assisting challenged readers of claim 6, wherein said colorizing step further comprises removing said identified prefixes and suffixes from each said word and converting each said word to a root word and then comparing each said identified root word to a syllable text string dictionary located in a syllable data repository of said central computing device and responsively identifying the syllables making up each said identified root word.

8. The method for assisting challenged readers of claim 7, wherein said colorizing step further comprises converting each said root word to said word text string and identifying said prefixes and suffixes as additional identified syllables.

9. The method for assisting challenged readers of claim 8, wherein said colorizing step further comprises coloring said identified syllables in each said identified word according to a pre-determined syllable colorization rule subset, said syllable colorization rule subset forming a portion of said pre-determined colorization ruleset.

10. A document conversion method, comprising the steps of:
a user transmitting an input document from an input computing device to a central computing device, said input document comprising data in the form of strings of text in an input sequence order;
said central computing device analyzing each individual said string of text and determining whether said string of text is a word or a non-word by comparing said string of text to a word data repository located in said central computing device;
extracting said words and non-words identified in said analyzing step from said text string;
colorizing words identified in said analyzing step according to a pre-determined colorization ruleset;
adding said colorized words and non-word strings of text to an output document in said input sequence order;
transmitting said output document to said input computing device.

11. The method of claim 10, wherein said colorizing step comprises comparing each said identified word to a syllable text string dictionary located in a syllable data repository of said central computing device and responsively identifying the syllables making up each said identified word.

12. The method of claim 11, wherein said colorizing step further comprises coloring said identified syllables in each said identified word according to a pre-determined syllable colorization rulesubset, said syllable colorization rule subset forming a portion of said pre-determined colorization ruleset.

13. The method of claim 10, wherein said colorizing step further comprises comparing each said identified word to a syllable text string dictionary located in a syllable data repository of said central computing device and responsively comparing each said identified word to a prefix text string dictionary and a suffix text string dictionary located in prefix data repository and suffix data repository, respectively, of said central computing device and responsively identifying prefixes and suffexes in each said identified word.

14. The method of claim 13, wherein said colorizing step further comprises removing said identified prefixes and suffixes from each said word and converting each said word to a root word and then comparing each said identified root word to a syllable text string dictionary located in a syllable data repository of said central computing device and responsively identifying the syllables making up each said identified root word.

15. The document conversion method of claim 14, wherein said colorizing step further comprises converting each said root word to said word text string and identifying said prefixes and suffixes as additional identified syllables.

16. The document conversion method of claim 15, wherein said colorizing step further comprises coloring said identified syllables in each said identified word according to a pre-determined syllable colorization rule subset, said syllable colorization rule subset forming a portion of said pre-determined colorization ruleset.

17. The document conversion method of claim 12, wherein said syllable colorization rule subset comprises colorizing single syllable words in black.

18. The document conversion method of claim 17, wherein said syllable colorization rule subset comprises colorizing the initial syllable of a word string comprising three or more syllables in blue.

19. The document conversion method of claim 18, wherein said syllable colorization rule subset comprises colorizing the final syllable of a word string comprising more than one syllable in orange.
